(19) United States
(12) Patent Application Publication
(10) Pub. No.: US 2003/0046043 A1
(43) Pub. Date: Mar. 6, 2003

(54) Isotropic vector field decomposition method for use in scientific computations

(76) Inventor: James Fredrick Nystrom, Corpus Christi, TX (US)

Correspondence Address: Dr. J. F. Nystrom, 406 Chase Dr., Corpus Christi, TX, 78412, US

(21) Appl. No.: 09/944,563

(22) Filed: Sep. 4, 2001

(51) Int. Cl. G06F 17/10

(52) U.S. Cl. 703/2

(57) ABSTRACT

An isotropic vector field decomposition method for use in scientific computations with the steps of: a computational grid modeled on a specific arrangement of nodes, such that each node is equidistant from it's twelve nearest neighbors, a vector field decomposition technique utilizing six vector components at every node within the associated isotropic vector matrix, and techniques for implementing standard vector calculus operations within the isotropic vector matrix. A preferred embodiment includes wherein said techniques can be used to create an algorithm to solve computational electromagnetic problems, or any physical problem involving the use of vector fields.

### BACKGROUND OF THE INVENTION

This invention relates generally to the field of scientific computation and simulation, and more particularly to scientific computations which utilize vector field quantities.

Computational methods of modeling and predicting physical phenomena have traditionally used a Cartesian or other three-tuple systems (collectively known as curvilinear coordinate systems) as a basis for describing the vector fields involved in modeling the said physical phenomena. The aforementioned three-tuple basis chosen for describing the vector fields then dictates the mathematical methodology used to express standard vector calculus operations. The algorithms to model the physical phenomena implement in a discrete manner the inherently continuous vector calculus operations as expressed in the associated curvilinear coordinate system. Current computational methods typically involve a finite-difference approximation of the partial derivatives involved in the evaluation of standard vector calculus operations. The aforementioned finite-difference approximation can be of varying order of accuracy (in a Talyor series expansion sense). Note also that while most computational methods colocate all the components of each vector field at every node within a grid, some computational methods stagger the components (to produce an uncolocated grid—for example the Yee grid, which is used in some computational electromagnetic methods). Furthermore, not all grids use a consistent amount of spacing between grid points, producing stretched and/or unstructured grids.

The use of any standard set of curvilinear coordinates (and the associated three-tuple that expresses the vector field for that coordinate system) gives rise to grid anisotropicies. Said anisotropicies introduce directionally-oriented computational aberrations not associated with the underlying physical phenomena being studied. As an example, in Cartesian grid based computational electromagnetic solvers, the vector fields which represent the electric and magnetic fields propagate at different velocities along different trajectories within the grid—for instance, fields propagating along a Cartesian axis differ in velocity from fields propagating along a direction not aligned with a Cartesian axis.

### SUMMARY OF THE INVENTION

The primary object of the invention is to provide more accurate computerized simulations of physical phenomena by alleviating the inherent grid anisotropicy of Cartesian grid (and other standard grids) based simulations.

Other objects and advantages of the present invention will become apparent from the following descriptions, taken in connection with the accompanying drawings, wherein, by way of illustration and example, an embodiment of the present invention is disclosed.

An isotropic vector field decomposition method for use in scientific computations comprising the steps of: a computational grid modeled on a specific arrangement of nodes, such that each node is equidistant from it's twelve nearest neighbors (this grid is hereafter referred to as an isotropic vector matrix (IVM)), a vector field decomposition technique utilizing six vector components at every node within the associated IVM, and techniques for implementing standard vector calculus operations within the associated IVM. The preferred embodiment of the invention are algorithms for computational electromagentics, computational fluid dynamics, and other general scientific applications which involve vector field quantities.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is the basic VE cell with a chosen Cartesian orientation.

FIG. 2 is a two-frequency IVM.

FIG. 3 shows the six basis vectors of the VE cell.

FIG. 4 shows the a-plane of the VE cell.

FIG. 5 shows the b-plane of the VE cell.

FIG. 6 shows the c-plane of the VE cell.

FIG. 7 shows the d-plane of the VE cell.

FIG. 8 shows the calculation of S₃.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

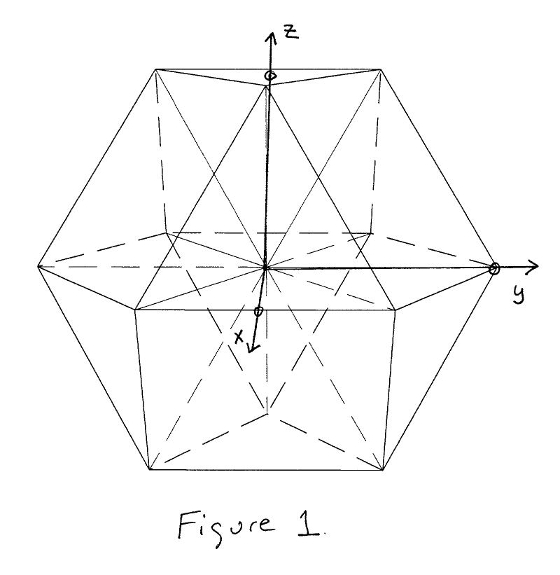

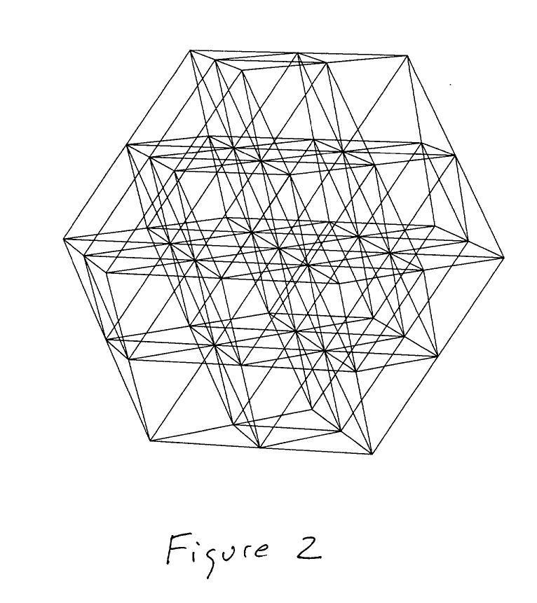

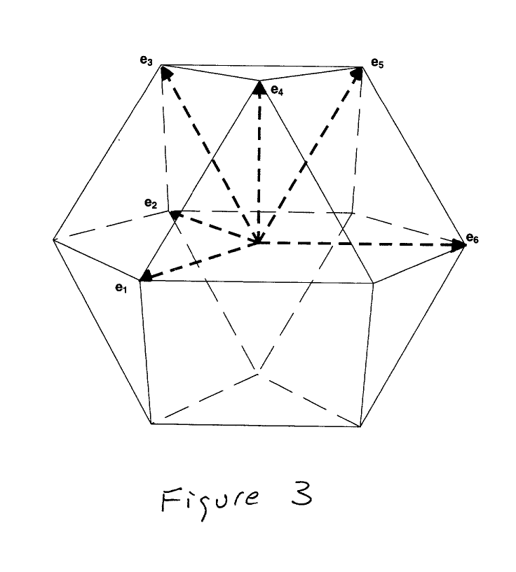

Turning first to FIG. 1, there is shown a basic cell whose 12 exterior vertices are all equidistant from the center node. For the remainder of the description, the basic cell in FIG. 1 is called the VE cell (or just the VE). Turning now to FIG. 2, there is shown a sample version of an isotropic vector matrix, which is built upon the basic VE cell. To accomplish an important function of this invention, there is shown in FIG. 3 the six basis vectors of the VE cell: e₁- e₆. For definitiveness, the six basis vectors in FIG. 3 are now expressed in Cartesian coordinates (in accordance with the Cartesian orientation shown in FIG. 1):

e₁=aₓ(√3/2)−a_{y}(1/2),

e₂=−aₓ(√3/2)−a_{y}(1/2),

e₃=−aₓ(1/2√3)−a_{y}(1/2)+a_{z}(√2/√3),

e₄=aₓ(1/√3)+a_{z}(√2/√3),

e₅=−aₓ(1/2√3)+a_{y}(1/2)+a_{z}(√2/√3),

e₆=a_{y}.

Note that the basis vectors e₁-e₆ have unit length as do the standard Cartesian unit vectors aₓ-a_{z}. Also know that (from inspection):

e₄=e₃−e₂,

e₅=e₃−e₂−e₁,

e₆=−e₁−e₂.

The basic VE cell has twelve vertices around the center node. We can use a six-tuple to reference all of these aforementioned twelve points, with each element of the tuple representing a displacement in the corresponding unit vector direction. The center of the VE cell will be designated to have an address of (0,0,0,0,0,0), and the vertice designated with the address (1,0,0,0,0,0) represents the point at the tip of the basis vector e₁. A shorthand notation for the vertice at (1,0,0,0,0,0) is (+1). That is, we will use (−6) to represent the vertice at (0,0,0,0,0,−1).

We now describe a method to construct the vector calculus curl operator on the VE cell. For the development of this finite-difference style evaluation of the curl within the VE, we use two vector S and T, which are related by the equation S=∇×T, which is to be evaluated at S(0), which requires values of the vector T at T(+1), T(−1), T(+2), T(−2), T(+3), T(−3), T(+4), T(−4), T(+5), T(−5), T(+6), and T(−6). That is, we use the value of T at all twelve exterior points of the VE cell to obtain an approximation of S at the center of the VE cell. Moreover, the vectors S and T will be written is terms of the VE basis vectors; that is:

S=S₁e₁+S₂e₂+S₃e₃+S₄e₄+S₅e₅+S₆e₆,

T=T₁e₁+T₂e₂+T₃e₃+T₄e₄+T₅e₅+T₆e₆.

Within the framework of the VE cell, we want to evaluate S=∇×T, which is defined (as shown in any advanced vector calculus text) as

S=lim_{dA→0}(1/dA)[n [symbol] T·dl],

where dA is the area enclosed by the contour of integration, and n is the unit vector is the direction which makes the right-hand side of the equation takes on its maximum value. The contour integral in the definition is commonly called the circulation; which is a term that will be used in the remainder of this description. To accomplish an important aspect of the invention, we will evaluate contours around the four hexagonal planes of the VE cell. The four hexagonal planes of the VE cell are labeled the a-plane, the b-plane, the c-plane, and the d-plane. The aforementioned contours on the four hexagonal planes of the VE cell include only the exterior points of the VE cell, with each plane containing a unique set of six points. The exterior vertices on each of the hexagonal planes that make up the four contours are (with the vertices in this order):

a-plane: (+1) (−2) (+6) (−1) (+2) (−6)

b-plane: (+1) (+4) (+5) (−1) (−4) (−5)

c-plane: (−2) (+4) (+5) (−1) (−4) (−3)

d-plane: (−5) (−3) (+6) (+5) (+3) (−6)

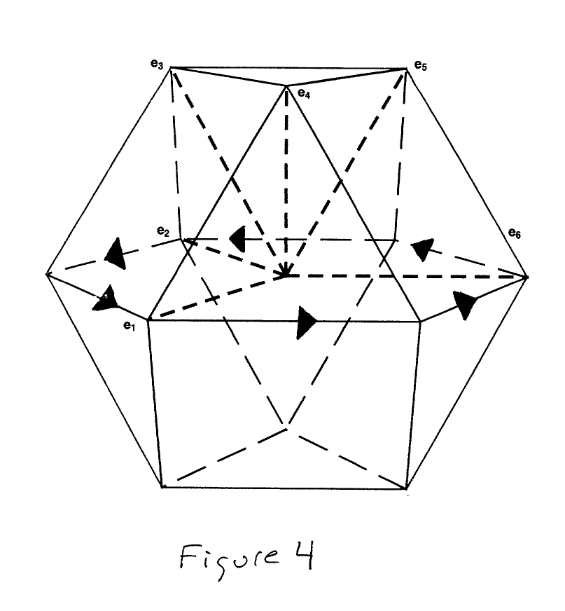

For each of the four contours to be evaluated, note that the lefthand side of the curl involves three components of the S vector in the VE basis. We now evaluate the circulation around the a-plane that is shown in FIG. 4, and take the dot product of the result against the unit vector normal to the a-plane, nₐ (=a_{z} in this case). Thus

(S₃e₃+S₄e₄+S₅e₅)·nₐ=(1/dA)[ [symbol] T·dl]ₐ.

Note that

e₃·nₐ=e₄·nₐ=e₅nₐ=(√2/√3),

thus

$$\begin{matrix}( {S}_{3} + {S}_{4} + {S}_{5} ) = ( √ 3 / √ 2 ) {( 1 / d A ) [ ∮ T \cdot d l ]}_{a} , \\ = {a}^{′} ,\end{matrix}$$

which defines the variable a′. That is, a′=(√3/√2)(1/dA) [symbol] T·dl]ₐ. The evaluation of a′, as it involves standard vector calculus techniques available in the literature, will not be discussed herein.

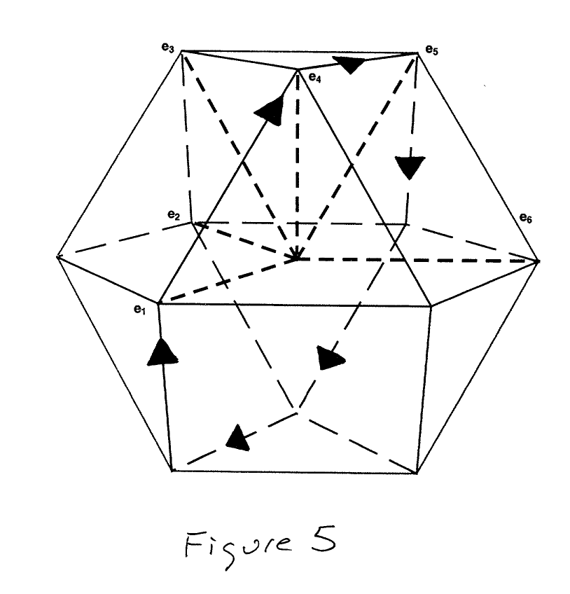

The evaluation of the contour around the b-plane that is shown in FIG. 5 results in the following equation:

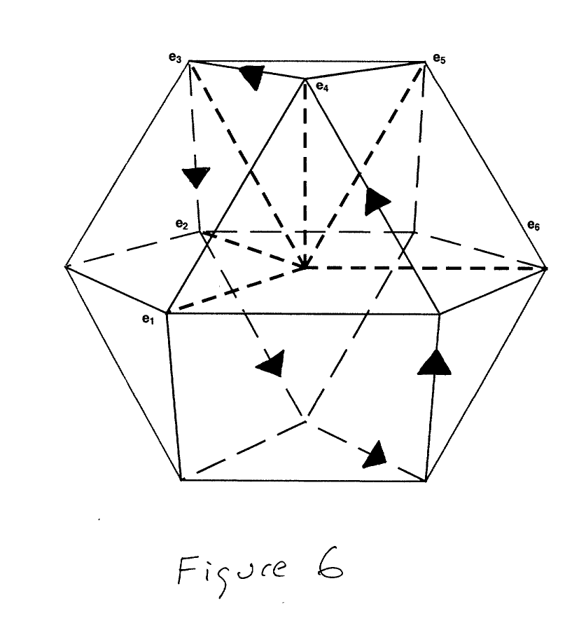

(S₂+S₃−S₆)=b′,

where b′=(√3/√2)(1/dA) [symbol] T dl]_{b}. The evaluation of the contour around the c-plane that is shown in FIG. 6 results in the following equation:

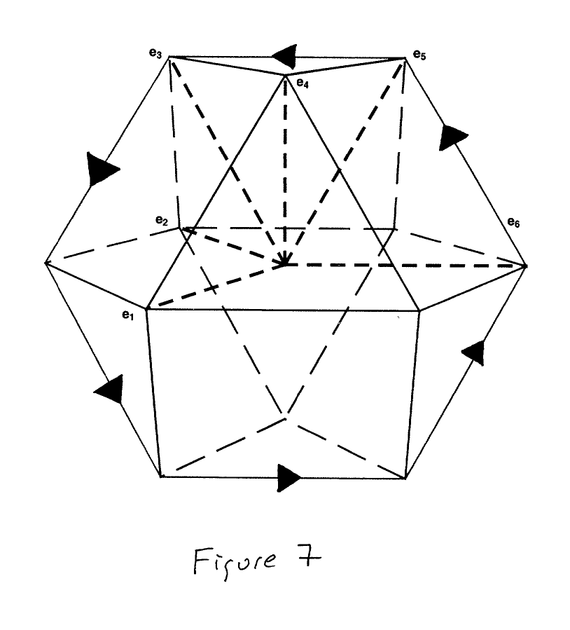

(S₁−S₅−S₆)=c′,

where c′=(√3/√2)(1/dA) [symbol] T·dl]_{c}. The evaluation of the contour around the d-plane that is shown in FIG. 7 results in the following equation:

(S₁−S₂+S₄)=d′,

where d′=(√3/√2)(1/dA) [symbol] T·dl]_{d}. Evidently, as the equations from the four contours show,

a′−b′+c′−d′=0.

In accordance with an important part of the invention, the values for the components of the resulting S vector can now be written:

S₁=(c′+d′)/4,

S₂=(b′−d′)/4,

S₃=(a′+b′)/4,

S₄=(a′+d′)/4,

S₅=(a′−c′)/4,

S₆=(−b′−c′)/4.

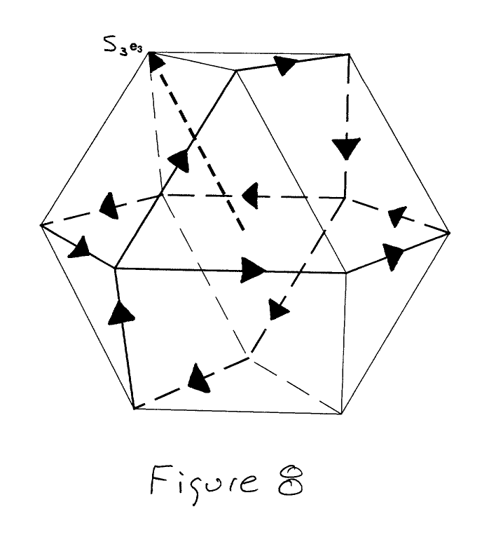

which describes how to discretely approximate the vector calculus curl function on a VE cell, and within an associated isotropic vector matrix. In FIG. 8 is shown the evaluation of the S₃ component of S—which involves the a′ and b′ contours. The divergence of a vector field and the gradient can also be derived within the framework of this isotropic vector field decomposition method.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An isotropic vector field decomposition method for use in scientific computations comprising the steps of:
a computational grid modeled on a specific arrangement of nodes, such that each node is equidistant from it's twelve nearest neighbors (this basic arrangement forms a VE cell, and the grid that is produced is hereafter referred to as an isotropic vector matrix (IVM));
a vector field decomposition technique utilizing six vector components at every node within the VE cell and the associated IVM grid; and
techniques for implementing standard vector calculus operations within the basic VE cell and the associated IVM grid.

2. An isotropic vector field decomposition method for use in scientific computations as claimed in claim 1 wherein said techniques can be used to create an algorithm to solve computational electromagnetic problems.

3. An isotropic vector field decomposition method for use in scientific computations as claimed in claim 1 wherein said techniques can be used to create an algorithm to solve computational fluid dynamics problems.

4. An isotropic vector field decomposition method for use in scientific computations as claimed in claim 1 wherein said techniques can be used to create an algorithm to solve computational acoustics and computational aeroacoustics problems.

5. An isotropic vector field decomposition method for use in scientific computations as claimed in claim 1 wherein said techniques can be used to create an algorithm to solve any general problem which includes the use of vector field quantities.
